(19) United States
(12) Patent Application Publication
(10) Pub. No.: US 2024/0181416 A1
(43) Pub. Date: Jun. 6, 2024

(54) QUENCH MIXING DEVICE FOR MULTI-BED DOWNFLOW REACTORS

(71) Applicant: HINDUSTAN PETROLEUM CORPORATION LIMITED, Mumbai (IN)

(72) Inventors: Valavarasu GNANASEKARAN, Bengaluru (IN); Pradyut Kumar DHAR, Bengaluru (IN); Samuel Jedidiah MEKALA, Bengaluru (IN); Bojja RAMACHANDRA RAO, Bengaluru (IN)

(21) Appl. No.: 18/285,185

(22) PCT Filed: Mar. 26, 2022
(86) PCT No.: PCT/IN2022/050307

§ 371 Date: Sep. 29, 2023

(30) Foreign Application Priority Data
Mar. 30, 2021 (IN) 202121014511

(51) Int. Cl. B01J 8/04

(52) U.S. Cl. CPC B01J 8/0492; B01J 8/0453; B01J 2208/00849; B01J 2208/00938

(57) ABSTRACT

A quench mixing device (100, 200, 300) is disclosed for mixing multiphase process fluids in 5 the inter-bed region of a concurrent downflow reactor (10) for obtaining homogeneity of the temperature and chemical composition of the mixed stream. The quench mixing device comprises of outer mixing zone (109), inner mixing zone (120), swirl mixing zone (151) and exit zone. Due to the position of the disperser (142), the liquid coming from above is dispersed in droplets. The fluid impact on the other side of the outer mixing zone. The gas is bubbled into 0 liquid in the inner mixing zone. The fluids enter the swirl mixing zone via two-phase duct (131) which is shaped to have low pressure loss and high velocity at the outlet to induce dispersed regime. The outlet of the two-phase duct is placed such that liquid is injected into the swirl zone below liquid surface, causing increased momentum for inducing liquid swirl in the swirl zone and increased number of rotations.

### FIELD OF THE INVENTION

The present invention generally relates to downflow reactors and more particularly relates to quench mixing devices for multi-bed downflow reactors.

### BACKGROUND OF THE INVENTION

It is well known that in multi-bed reactors, the processes require a concurrent downward flow of fluid reactants over a bed of solid particles. For a successful process it is required that the fluid(s) reactants come in contact with the surface of the solid particles uniformly, for there to be effective heat and mass transfer and reaction. Various internals are used in the reactor for aiding in the effective contact between reactant fluids and the solid particles. A distributor is used for spreading of the liquid and vapor across the top of the catalyst bed. A quench mixing device is used to equilibrate the temperature and composition of the gas and liquid mixture exiting the device. Variations in temperature and composition occurring in the radial direction of the reactor are to be minimized for uniform utilization of the catalyst, thereby lengthening the catalyst life.

Hydro-processing reactors have an axial increase in temperatures because of the exothermic nature of the reaction. In order to limit the increase in the temperatures, the catalyst bed size is divided, and quench fluid, typically hydrogen is injected at the interbed locations. This process of lowering the reactant liquid temperature employing quench fluid is called quenching. The inter-bed region of quenching is called the quench zone.

The reactions in the hydro-processing reactors are accelerated due to temperature. With variations in radial temperature, the reaction is accelerated in one location over other locations. And due to the exothermic nature of the reaction, the temperature is further increased. The process can result in the formation of hotspots in the reactor, which reduce the overall catalyst life, due to premature exhaustion of catalysts in the hotspot region. The high temperatures due to the exothermic reactions are also to be lowered to avoid thermal cracking of the valuable products to less valuable lighter products.

The quench zone comprises of a reactant collection system, quench fluid injection device, a chamber or area for mixing reactant liquid and gas with incoming quench fluid, and a reactant redistribution tray.

Various designs for mixing devices include baffle-type designs in which liquid and gas pass through channels changing flow directions. And the fluids may pass through constrained spaces or orifices in the flow path. Mixing occurs as the fluid passes through areas of increasing and decreasing cross-sectional area. This type of quench device has a higher pressure drop as the fluid has to pass through constrained spaces and longer paths. An example of such a quenching device is known from U.S. Pat. No. 7,276,215.

In vortex type of quench mixers, liquid and gas swirl in a mixing chamber. Although there can be good gas mixing and acceptable liquid mixing, the interphase mixing is low, as the liquid and gas are separated in the mixing chamber due to the density differences between gas and liquid. In an example of this kind of quench mixer U.S. Pat. No. 10,589,244, there is only rotational mixing. The gas enters the swirl mixing zone above the liquid level, as a result, the momentum for inducing rotations is reduced. More examples of this vortex type of quench device are U.S. Pat. Nos. 7,045,103, 7,112,312, 9,403,139.

In conventional impingement type quench mixers, separate paths for liquid and gas are taken resulting in poor interphase mixing. Examples of this type of quench device are U.S. Pat. Nos. 4,669,890, 3,502,445. In another example, E.P. Patent No. 0716881, the paths of liquid and gas are separate before mixing. The liquid passes the swirl vanes and impinge other streams of liquid. In U.S. Pat. No. 5,904,907 the mixing occurs only due to impact.

In another example CN2738876Y discloses a quench mixing device being used in a multi-bed downflow reactor, wherein three annular flow channels are provided such that the outer annular flow channel receives the fluid from two opposite inlets and thus colliding in the midway of the outer annular flow channel and hence inducing mixing. However, such a device has lower interphase mixing as the fluids separate in the mixing chamber due to density differences, and lack of proper dispersion system.

In another example U.S. Pat. No. 10,486,127 B2, quench gas injection is through a ring injector. The mixing mainly occurs in the mixing channel. The gas enters the inner mixing chamber below the liquid level, only in the mixing channel.

In yet another example U.S. Pat. No. 9,452,411 B2 quench gas is injected at the inlet of the annular mixing pipe, at different positions and rotation occurs in the mixing pipe and pre-distributor tray.

There lies an undressed need of a concurrent downflow reactor having inter-bed region that provides at least homogeneity of the temperature and chemical composition of the mixed stream of fluids.

### SUMMARY OF THE INVENTION

This summary is provided to introduce a selection of concepts in a simplified format that is further described in the detailed description of the invention. This summary is not intended to identify key or essential inventive concepts of the claimed subject matter, nor is it intended for determining the scope of the claimed subject matter.

In accordance with the purposes of the subject matter, the present invention as embodied and broadly described herein comprises a quench mixing device that has impact mixing, rotational mixing, and mixing due to flow through constrained spaces.

In accordance with an embodiment of the present invention, the quench mixing device comprises of an outer mixing zone, an inner mixing zone, a swirl mixing zone and an exit zone. The quench gas in injected below the upper plate via a disperser. The end of the disperser has slots with gas inlet into the outer mixing zone. Due to the position of the disperser, the liquid coming from above is dispersed in droplets. The fluid impact on the other side of the outer mixing zone. The gas is bubbled into liquid in the inner mixing zone. The fluids enter the swirl mixing zone via two-phase duct which is shaped to have low pressure loss and high velocity at the outlet to induce dispersed regime. The fluids enter the swirl mixing zone tangentially, thereby having increased number of rotations. Due to the presence of vanes in the exit region, there is induced rotation in the exit zone. With the semi-circular sieve plates, there is reduced requirement of space between the pre-distributor tray and bottom of the quench mixer.

In accordance with other embodiment of the present invention a quench mixing device for a multibed hydro-processing reactor is disclosed. The quench mixing device comprises an outer mixing zone formed between a reactor wall and an outer wall, the outer mixing zone adapted to receive a first fluid from a pair of spillways, wherein the first fluid is received in two streams through a partition plate, and a quench gas is received through a quench disperser and wherein the first fluid contacts the quench gas and dispersed within the outer mixing zone to form a first quench fluid and a second quench fluid. Further, an inner mixing zone formed between the outer wall and an inner wall, the inner mixing zone adapted to receive the first quench fluid and the second quench fluid from the inner mixing zone: and guide the first quench fluid and the second quench fluid through a two-phase duct towards a swirl mixing zone for mixing.

In accordance with another embodiment of the present invention a quench mixing device for a multibed hydro-processing reactor is disclosed. The quench mixing device, comprises an outer mixing zone formed between a reactor wall and an outer wall. The outer mixing zone adapted to receive a first fluid tangentially from a collection duct extending horizontally across a predefined length on the reactor wall, and a quench gas is received through a quench disperser to disperse quench gas bubbles, wherein the quench gas bubbles contact the first fluid to convert into droplets and form a first quench liquid. Further, an inner mixing zone is formed between the outer wall and an inner wall, the inner mixing zone adapted to: receive the first quench fluid from the outer mixing zone: and guide the first quench fluid through a two-phase duct towards a swirl mixing zone for mixing.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present invention will become better understood when the following detailed description is read with reference to the accompanying drawings in which like characters represent like parts throughout the drawings, wherein:

FIG. 1 illustrates a multi-bed hydro-processing reactor, in accordance with an embodiment of the present invention;

FIGS. 2a and 2b illustrate a side-sectional view and a top-sectional view, respectively, of the first embodiment of the quench mixing device, in accordance with an embodiment of the present invention:

FIG. 3 illustrates a side-sectional view at section S5 depicted in FIG. 2b of the first embodiment of the quench mixing device, in accordance with the embodiment of the present invention:

FIGS. 4a, 4b, and 4c illustrate side cross-sectional views of the two-phase duct at sections S6, S7, S8 depicted in FIG. 2b of the first embodiment of the quench mixing device in accordance with the embodiment of the invention:

FIG. 5 depicts line graph indicating the estimated number of rotations of the embodiments of the present invention compared to conventional vortex quench mixer of prior art, for the same fluids flow rates and pressure drop:

FIGS. 6a and 6b illustrate a top sectional view and a side sectional view, respectively, of the second embodiment of the quench mixing device, in accordance with another embodiment of the present invention:

FIG. 7 illustrates a cross-sectional view of a bubble cap of the second embodiment of the quench mixing device, in accordance with the embodiment of the present invention:

FIG. 8 illustrates a cross-sectional view of a collection duct of the second embodiment of the quench mixing device, in accordance with the embodiment of the present invention:

FIG. 9 illustrates a cross-sectional view of a two-phase duct of the second embodiment of the quench mixing device, in accordance with the embodiment of the present invention:

FIGS. 10a and 10b illustrate a top projection view and a side cross-sectional view respectively, of the of third embodiment of the quench mixing device in accordance with another embodiment of the present invention:

FIG. 11 illustrates a cross-sectional view of gas-liquid duct of the third embodiment of the quench mixing device, in accordance with the embodiment of the present invention; and

FIG. 12 illustrates a cross-sectional view of gas duct of the third embodiment of the quench mixing device in accordance with the embodiment tof the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

In accordance with various embodiments of the present invention, a quench mixing device described herein is positioned in the space between beds of particles in a co-current downflow vessel. In an example the quench mixing device can be placed in between beds of catalyst particles in a hydro-processing reactors. The intermediate space between the catalyst beds is provided for injection of quench fluid into the reactor, which is typically for the purpose of cooling the fluids from the upper bed. The quench mixing device is used for equilibrating the temperature and composition of the fluids from the upper bed and the quench fluid, before entering the lower bed.

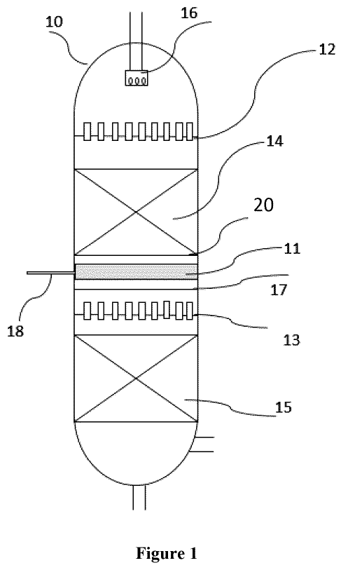

FIG. 1 illustrates a multi-bed hydro-processing reactor 10 with quench mixing device 11 in accordance with the embodiments of the present invention. The quench mixing device 11 may be located in the intermediate space between upper catalyst bed 14 and lower catalyst bed 15. The gas and liquid enter through inlet nozzle 16 and are distributed by gas-liquid distributor tray 12. The upper and lower catalyst beds, 14 and 15, are supported on catalyst supporting grid 20, through which the fluids may fall in the region of quench mixing device 11, where the quench gas injected in the quench mixer through quench pipe-line 18. The outlet fluid from the quench mixing device fall on the pre-distributor tray 17 and further on distributor tray 13 into the lower catalyst bed 15. The hydro-processing reactor 10 may contain more than two catalyst beds, without departing from the scope of the present invention.

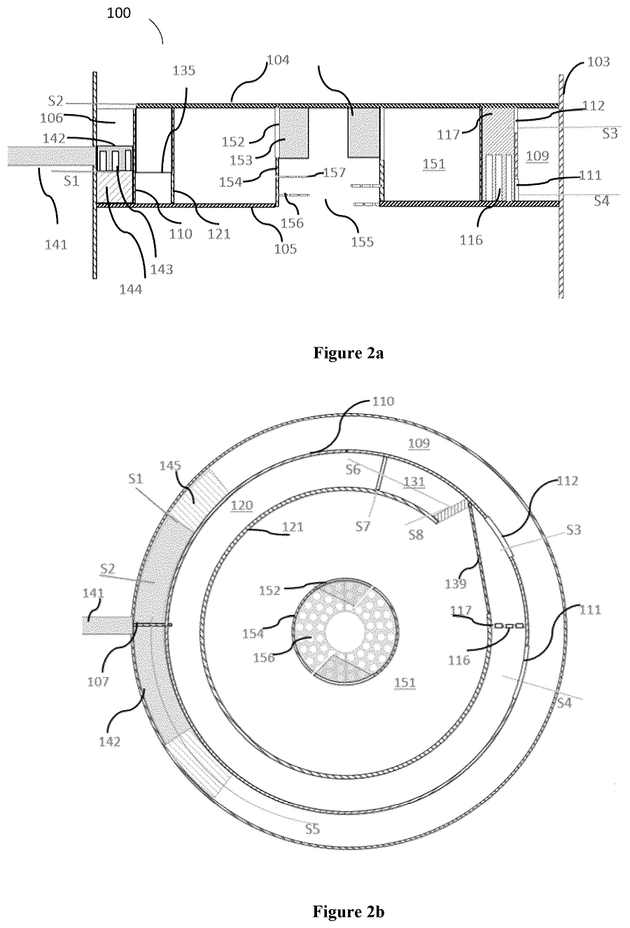

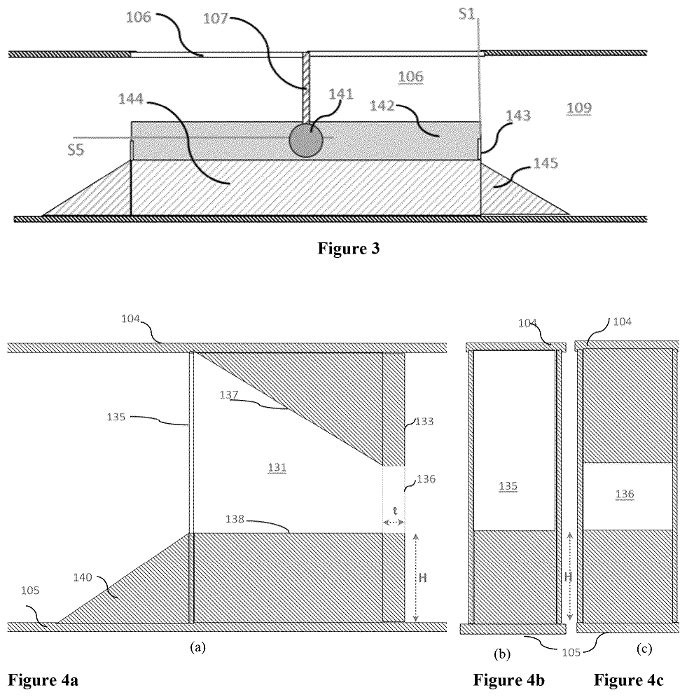

FIGS. 2a and 2b illustrate a side-sectional view and a top-sectional view, respectively, of the first embodiment of the quench mixing device 100, in accordance with an embodiment of the present invention. FIG. 3 illustrates a side-sectional view at section S5 depicted in FIG. 2b of the first embodiment of the quench mixing device 100, in accordance with the embodiment of the present invention. FIGS. 4a, 4b, and 4c illustrate side cross-sectional views of the two-phase duct at sections S6, S7, S8 depicted in FIG. 2b of the first embodiment of the quench mixing device 100 in accordance with the embodiment of the invention. For the sake of brevity, FIG. 2a, FIG. 2b, FIG. 3, FIG. 4a, FIG. 4b, and FIG. 4c are explained in conjunction with each other.

The quench mixing device 100 is positioned between an outer collection tray 104 and a lower plate 105. The outer collection tray 104 and the lower plate 105, are bounded by a reactor wall 103. The liquid from the upper catalyst bed 102 of the reactor 10, is collected in the outer collection tray 104. A first fluid from, for example, liquid and gas pass through at least two spillways 106 disposed on the outer collection tray 104. The at least two spillways 106 are separated by a partition plate 107. An outer partition wall 110 is positioned at a predetermined radial distance from the reactor wall 103 may form an outer mixing zone 109 where the liquid and gas are received. The outer partition wall may be present at the outermost region of the quench mixing device 100 and act as a reactor wall 103 without departing from the scope of the present invention. An inner partition wall 121 positioned at a predetermined radial distance in an inward direction from the outer partition wall 110 may form an inner mixing zone 120. In some embodiments, the outer partition wall 110 may include a plurality of liquid slots 111 in the lower region of the outer partition wall 110. Further, a plurality of gas slots 112 are disposed within the upper region of the outer partition wall 110. The variations in size of the plurality of liquid slots 111 size may be maintained in the outer mixing zone 109 in order to vary the amount of liquid entering therein. The streams of gas and liquid pass through the constrained area of upper gas slots 112 and lower liquid slots 111 on the outer partition wall respectively, and flow into the inner mixing zone, inducing mixing.

Further, the quench gas is injected into the outer mixing zone 109, through a quench gas injector line 141. An outlet of the quench gas injector line 141 is connected to a quench gas disperser 142 that may be positioned below the at least two spillways 106. The quench gas disperser 142 consists of a duct including a plurality of quench gas slots 143. The plurality of quench gas slots may be interchangeably referred as “quench gas slots” without departing from the scope of the present disclosure. As quench gas is injected below the outer collection tray 104, the space requirement for the quench gas injector line 141 is reduced, resulting in reduced height of the quench zone. The liquid collected in the spillways 106 comes in contact with the quench gas coming out of the quench gas slots 143. Due to the high velocity of the quench gas coming out of the gas slots 143, the liquid is dispersed as it enters the outer mixing zone 109. The quench gas disperser is placed on a support block 144, at a certain height “h” above the lower plate 105. Further, a triangular shaped block 145 is placed on both sides of support block 144 to provide path for liquid flow.

The liquid and gas pass through the two spillways 106 disposed on the outer collection tray 104 and passes into the outer mixing zone 109. The two spillways 106 are separated by a partition plate 107. Thus, the gas and liquid pass in two streams from the two spillways 106. The two streams impact each other on the other side of the outer mixing zone 109. The gas and liquid then pass through the slots on the outer partition wall. The liquid in the outer mixing zone 109 passes through the plurality of liquid slots 111 located a lower position, and gas passes through the quench gas slots 143 located at a higher position. The gas is then bubbled into the liquid through inner zone slots 116, placed on a baffle plate 117, inducing two-phase mixing between the gas and the liquid. The gas from the quench gas disperser 142 comes in contact with liquid from the spillways and the liquid is dispersed, causing an increased interphase area. The cold quench gas comes in contact with hot liquid, causing increased interphase heat and mass transfer.

An inner partition wall 121 comprises a two-phase duct 131 allowing the passage of fluids from an inner mixing zone 120 into a swirl mixing zone 151. The liquid and gas from the inner mixing zone 120 rotatably enter the swirl mixing zone 151 through the two-phase duct 131. The two-phase duct 131 consists of an inlet opening 135 and an outlet opening 136. The lower edge of the inlet opening 135 opening is at a certain height “H” above the top of the lower plate 105. The entry into the two-phase duct 131 is provided with wedge 140 of height H, so that liquid enters the two-phase duct 131 with low pressure loss while entering the two-phase duct 131. An upper surface 137 of the two-phase duct may be, but is not limited to, inclined at an angle 30° to 60° with the horizontal and a lower surface 138 of the two-phase duct may be horizontal. Thus, the cross-sectional area of the two-phase duct 131 is decreased in the direction of the flow. The thickness “t” of the outlet opening 136 may be in the range of 10 mm to 20 mm, in order to provide horizontal momentum for the fluid coming out of the two-phase duct 131.

The upper edge of the outlet opening 136 is just below or at the lower edge of the outlet slots 152, resulting in the liquid level just above the outlet opening 136. This results in fluid entry from the two-phase duct just below the liquid level. This ensures that the gas does not directly exit the swirl mixing zone. The two-phase duct 131 outlet 136 is covered by liquid surface, causing the dispersion of the liquid into droplets. The outlet opening 136 is sized to provide minimum velocity required to have dispersed regime at the outlet opening.

The outlet to the two-phase duct 131 is arranged such that the two-phase fluid enters the swirl mixing zone 151 in tangential flow. As the wall segment 139 is positioned to be tangential to the inner partition wall 121. The angle α between inner partition wall 121 and the outlet opening surface 133 is between 65° to 85° preferentially 70° to 80°. Since the liquid and gas enter tangentially and at a high velocity into the swirl mixing zone 151, below the liquid surface, the momentum of the fluids pushes the liquid in the swirl mixing zone, resulting in increased angular momentum, and number of rotations. Compared to conventional vortex mixing device, where the liquid and gas enter the swirl mixing region above the liquid level.

The minimum liquid level in the swirl zone is determined by the lower edge of outlet slots 152 with directional outlet vanes 153 on the outlet weir 154, placed on the central opening 155 on the lower plate 105. The liquid from the outlet slots 152 flows to the semi-circular sieve plates 157 attached to the outlet weir 154. The semi-circular sieve plates 157 have apertures 156, through which the liquid falls onto the rough distribution tray 158. Due to the directional vanes 153, the liquid exits the swirl mixing zone in a rotational motion, further swirling on the semicircular sieve plates 157. Further, due to the semi-circular sieve plates 157, the liquid falls on the rough distribution tray at reduced impact, on the rough distribution tray 157, without needing an impingement plate. Furthermore, due to the tapered discharge of the outgoing liquid below the quench mixing device, the space between the pre-distributor tray and bottom of quench mixer device can be lowered.

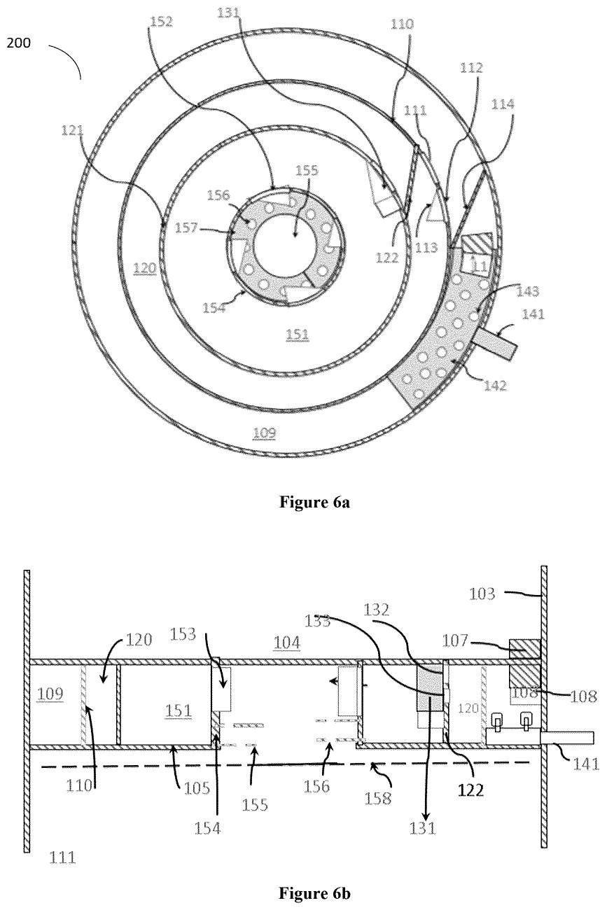

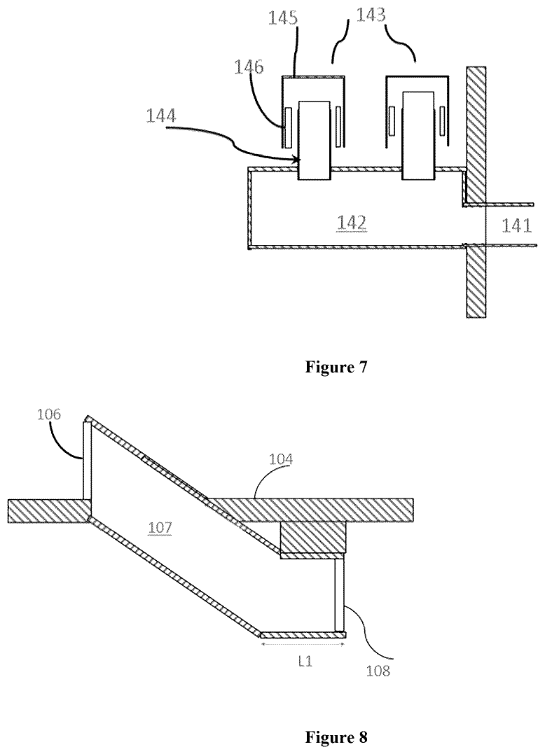

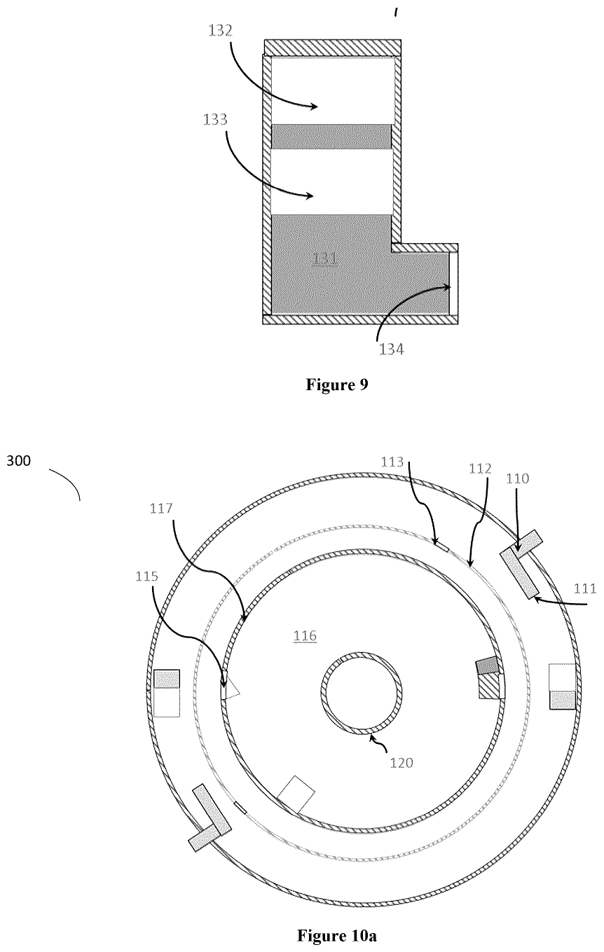

FIGS. 6a and 6b illustrate a top sectional view and a side sectional view, respectively, of the second embodiment of the quench mixing device, in accordance with another embodiment of the present invention. FIG. 7 illustrates a cross-sectional view of a bubble cap of the second embodiment of the quench mixing device, in accordance with the embodiment of the present invention. FIG. 8 illustrates a cross-sectional view of a collection duct of the second embodiment of the quench mixing device, in accordance with the embodiment of the present invention. FIG. 9 illustrates a cross-sectional view of a two-phase duct of the second embodiment of the quench mixing device, in accordance with the embodiment of the present invention. For the sake of brevity, FIG. 6a, FIG. 6b, FIG. 7, FIG. 8 and FIG. 9 are explained in conjunction with each other.

In accordance with another embodiment of the present invention, a quench mixing device 200 is disclosed. The quench mixing device 200 described herein is positioned in the space between the catalyst beds of particles in a co-current downflow vessel. For example, the quench mixing device 200 can be placed in between beds of catalyst particles in a hydro-processing reactor. The intermediate space between the catalyst beds is provided for injection of quench fluid into the reactor, which is typically for the purpose of cooling the fluids from the upper bed. The quench mixing device 200 may be used for equilibrating the temperature and composition of the fluids from the upper bed and the quench fluid, before entering the lower bed. The quench mixing device 200 may be bounded between collection tray 104 and lower plate 105. The outer collection tray and the lower plate 105, are bounded by the reactor wall 103. Liquid and gas collected in collection tray 104 from the upper bed 102 of the reactor vessel, pass through collection duct inlet 106 of the collection duct 107 and flows out through the collection duct outlet 108. The collection duct 107 has a certain horizontal length LI below the collection tray 104 in order to increase the horizontal component of fluid velocity coming out of the collection duct outlet 108. The liquid and gas coming out of the collection duct 107 are flown into the outer mixing zone 109.

An outer wall 110 is positioned at a certain radial distance from the reactor wall 103 forming the outer mixing zone 109. In some embodiments, the outer wall 110 may be present at the outermost region of the quench mixing device 200 and act as a reactor wall 103 without departing from the scope of the present invention. An inner wall 121 is positioned at a certain radial distance inward from the outer wall 110 forming the inner mixing zone 120. The outer wall 110 has liquid slots 111 placed on the lower edge, downstream in the outer mixing zone 109. The outer wall 110 has gas slots 112, with directing vane 113 at a distance downstream of the liquid slots 111. The inner wall 121 has two-phase duct 131, with passage of fluids from the inner mixing zone 120 into the swirl mixing zone 151.

A predetermined liquid level is maintained in the outer mixing zone 109, by sizing the liquid slot 111 on the outer wall 110. An outer baffle 114 is placed in the outer mixing zone 109 directing the gas through the gas slot 112 and liquid through liquid slot 111 placed on the outer wall 110. The presence of inner wall 121 ensures that a certain amount of liquid level is maintained in the outer mixing zone 109 at all flow rates of liquid.

Quench gas is injected into the outer mixing zone 109, through the quench gas injector line 141. The quench gas injector line 141 outlet is connected to a quench gas disperser 142. The disperser 142 is a box with openings on the top, having bubble caps 143 riser pipes 144 passing there through. The top of the quench gas disperser 142 comprises of bubble caps 143. The bubble cap 143 comprises of a riser pipe 144, with its lower end passing through the upper surface of the disperser 142. A cap structure 145 placed coaxially in proximity to the upper end of the riser pipe 144. The cap structure comprises of plurality of bubble cap slots 146 along the vertical surface of the cap structure. The plurality of bubble cap slots 146 may be interchangeably referred as a plurality of openings 146 without departing form the scope of the present invention. The quench gas passes through the plurality of riser pipes 144 and passes out through the bubble cap slots 146 into the liquid collected in the outer mixing zone 109. The bubble cap structure allows for the dispersion of quench gas into the liquid collected in the outer mixing zone 109. Also, the bubble caps ensure the liquid does not pass into the quench gas injector line 141 outlet. The quench gas in the form of dispersed bubbles comes in contact with the hot liquid from above bed. As the quench gas injection is into the liquid below the liquid surface, and due to the dispersion of liquid into droplets, there is improved interfacial heat transfer between cold quench gas and hot process liquid.

In the inner mixing zone 120, the gas slot 112 with directing vane 113 directs the gas in the inner mixing zone 120. The gas slot 112 is placed on the outer wall 110 such that the liquid level is slightly below the upper end of the gas slot. Thereby causing dispersion of liquid in the inner mixing zone 120. An inner baffle 122 is present in the inner mixing zone 120. The inner baffle 122 directs the fluids into the two-phase duct 131. The liquid and gas from the inner mixing zone 120, rotate in the zone, and enter the swirl mixing zone 151 through the two-phase duct 131.

The gas enters the two-phase duct 131 through gas opening 132 on the inner wall 121. The liquid enters the two-phase duct 131 through the liquid opening 133 on the inner wall. The liquid opening 133 is in the mid-section of the duct below the gas opening 132. The gas in the two-phase duct 131 comes in contact with the liquid and disperses into the swirl mixing zone 151. The two-phase duct 131 outlet 134 into the swirl mixing zone 151 is just below the liquid level that is maintained in the swirl zone. The liquid level in the swirl zone is determined by the lower edge of outlet slots 152 with directional outlet vanes 153 on the outlet weir 154, placed on the central opening 155 on the lower plate 105. The liquid from the outlet slots 152 flows to the plates 157 attached to the inner weir 154. The plates 157 have apertures 156, through which the liquid falls onto the rough distribution tray 158. Due to the presence of the plate 155, the liquid falls on the rough distribution tray at reduced impact, on the rough distribution tray 157, without needing an impingement plate.

The two-phase duct outlet 134 may be positioned at the same level horizontally as the outlet slots. As a result, the two-phase duct outlet 134 to be covered by liquid surface, causing the dispersion of the liquid into droplets. The two-phase duct 131 outlet 134 is sized to give sufficient velocity for the dispersion.

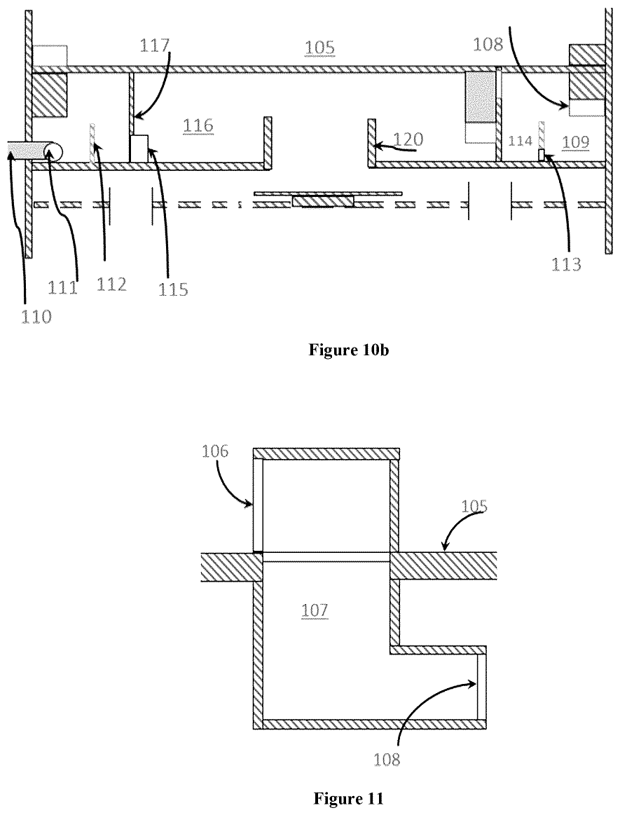

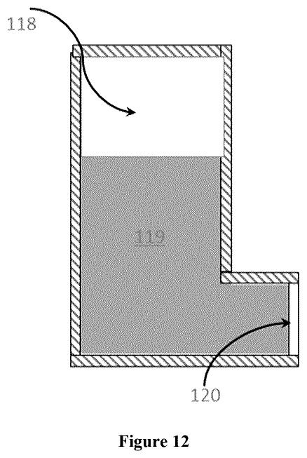

FIGS. 10a and 10b illustrate a top projection view and a side cross-sectional view respectively, of third embodiment of the quench mixing device 300 in accordance with another embodiment of the present invention. FIG. 11 illustrates a cross-sectional view of gas-liquid duct of the third embodiment of the quench mixing device 300, in accordance with the embodiment of the present invention. FIG. 12 illustrates a cross-sectional view of gas duct of the third embodiment of the quench mixing device 300 in accordance with the embodiment of the present invention. For the sake of brevity, FIG. 10a, FIG. 10b, FIG. 10c, FIG. 11, and FIG. 12 are explained in conjunction with each other.

In the quench mixing device 300 the liquid and gas collected in collection zone 105 passes through fluid opening 106 of the fluid duct 107 and passes out through the fluid outlet 108. The duct opening 108 is sized to give velocity such that there is dispersion of fluids out of the duct opening 108 and into the quench swirl zone 109. Further, quench gas is injected into the quench swirl zone 109, through the quench gas injectors 110 at a certain distance upstream of the duct opening. The position of the quench gas injectors is upstream of the fluid opening 107. The outlet of the quench opening 111 is located below the duct outlet 108 and a certain length behind the liquid opening. As the quench gas injection is into the liquid just below the liquid surface, there is dispersion of liquid into droplets increasing better interfacial heat transfer between gas and liquid. A baffle 112 is placed in the quench swirl zone 109 in order to maintain a certain amount of liquid level in the quench swirl zone 109. The baffle 112 also allows for increased number of rotations in the outer swirl zone. A slot 113 is placed on the lower end of the baffle 111, and upstream to the quench opening 111. A portion of the liquid passes through the slot 113. In some cases, the slot 113 is sized to allow 50% of the liquid through and the remainder of the liquid overflows from the baffle into the inner collection zone 114. The liquid from the inner collection zone 114 passes through the inner slot 115 into the inner swirl zone 116, formed by the swirl zone wall 117. The gas mixture of the quench gas and process gas passes from the swirl zone through the gas slot 112 on the swirl zone wall 117 and into the gas duct 119. The gas mixture passes through the gas duct and passes out through gas duct outlet 120. The gas duct outlet 120 is placed such that is positioned below the weir 120 of the inner swirl zone. Due to the swirling action, the liquid surface is slanted on the inner swirl zone. This further causes the gas duct outlet 120 to be partially covered by liquid surface, further increasing the dispersion of the liquid into droplets. The gas duct outlet 120 is sized to give sufficient velocity for the dispersion.

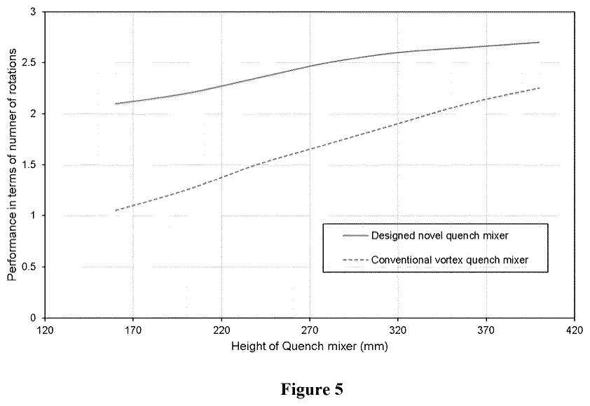

FIG. 5 depicts comparison between in the present quench mixing device 100, 200, 300 as compared to the conventional vortex mixer. The estimation was done for the same flow rates and pressure drop across both devices and accordingly an improved number of rotations were realized from the embodiments of the present invention.

The advantages of the present invention include, but not limited to, the present quench mixing device 100, 200, 300 has impact mixing, rotational mixing and mixing due to flow through constrained spaces. The device comprises of outer mixing zone, inner mixing zone, swirl mixing zone and exit zone. The quench gas in injected below the upper plate via a disperser. The end of the disperser has slots with gas inlet into the outer mixing zone. Due to the position of the disperser, the liquid coming from above is dispersed in droplets. The fluid impact on the other side of the outer mixing zone. The gas is bubbled into liquid in the inner mixing zone. The fluids enter the swirl mixing zone via two-phase duct which is shaped to have low pressure loss and high velocity at the outlet to induce dispersed regime. The fluids enter the swirl mixing zone tangentially, thereby having increased number of rotations. Due to the presence of vanes in the exit region, there is induced rotation in the exit zone. With the semi-circular sieve plates, there is reduced requirement of space between the pre-distributor tray and bottom of the quench mixer.

While specific language has been used to describe the present disclosure, any limitations arising on account thereto, are not intended. As would be apparent to a person in the art, various working modifications may be made to the apparatus system, and method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A quench mixing device for a multibed hydro-processing reactor, the quench mixing device comprising:
an outer mixing zone formed between a reactor wall and an outer partition wall, the outer mixing zone adapted to receive:
a first fluid from a pair of spillways, wherein the first fluid is received in two streams through a partition plate, and a quench gas is received through a quench disperser and wherein the first fluid contacts the quench gas and dispersed within the outer mixing zone to form a first quench fluid and a second quench fluid; and
an inner mixing zone formed between the outer wall and an inner wall, the inner mixing zone adapted to:
receive the first quench fluid and the second quench fluid from the inner mixing zone; and
guide the first quench fluid and the second quench fluid through a two-phase duct towards a swirl mixing zone in tangential flow, for mixing.

2. The quench mixing device as claimed in claim 1, comprising a plurality of inner zone slots on a baffle plate, wherein the quench gas enters the inner mixing zone through the plurality of inner zone slots.

3. The quench mixing device as claimed in claim 1, wherein the first quench fluid and the second quench fluid pass through constrained area of upper gas slots and lower liquid slots on an outer partition wall before flowing into the inner mixing zone for mixing.

4. The quench mixing device as claimed in claim 1, wherein the two-phase duct has a tapered profile adapted to increase velocity of an outgoing fluid.

5. The quench mixing device as claimed in claim 1, wherein the quench disperser is disposed below the pair of spillways.

6. The quench mixing device as claimed in claim 1, comprising a plurality of direction vanes in an outlet weir.

7. The quench mixing device as claimed in claim 6, comprising a plurality of semi-circular sieve plates in the outlet weir for tapered discharge of the outgoing fluid.

8. A quench mixing device for a multibed hydro-processing reactor, the quench mixing device, comprising:
an outer mixing zone formed between a reactor wall and an outer wall, the outer mixing zone adapted to receive:
a first fluid tangentially from a collection duct extending across a predefined length on the reactor wall, and a quench gas is received through a quench disperser to disperse quench gas bubbles, wherein the quench disperser comprises a bubble cap structure, and wherein the quench gas bubbles contact the first fluid to convert into droplets and form a first quench liquid;
an inner mixing zone formed between the outer wall and an inner wall, the inner mixing zone adapted to:
receive the first quench fluid from the outer mixing zone; and
guide the first quench fluid through a two-phase duct towards a swirl mixing zone for mixing.

9. The quench mixing device as claimed in claim 8, wherein the bubble cap structure includes:
a. a riser pipe passing through a plurality of holes on a top surface of the quench disperser, and
b. a cap structure proximal to an upper opening of the riser pipe comprising a plurality of openings on a vertical surface thereof.
